(19) United States
(12) Patent Application Publication
(10) Pub. No.: US 2022/0133582 A1
(43) Pub. Date: May 5, 2022

(54) Personal Grooming Device

(71) Applicant: Heather Downs, Louisville, KY (US)

(72) Inventor: Heather Downs, Louisville, KY (US)

(21) Appl. No.: 17/460,544

(22) Filed: Aug. 30, 2021

Related U.S. Application Data
(60) Provisional application No. 63/110,038, filed on Nov. 5, 2020.

(51) Int. Cl. A61H 7/00; A45D 20/12; A61H 23/02

(52) U.S. Cl. CPC A61H 7/005; A45D 20/12; A61H 23/02; A45D 2200/207; A61H 2201/1685; A61H 2201/025; A61H 2201/105; A61H 2201/1695; A61H 2201/0207

(57) ABSTRACT

The present invention relates generally to a personal grooming device. More specifically, the invention relates to a combination scalp massaging and hair drying device that has a plurality of vibrating nubs and a plurality of apertures positioned in spaced apart relationship across its head, a handle connected to the head for easy handling of the device, and a controller for controlling the flow of air through the plurality of apertures and the intensity, pressure, and speed of the vibrating nubs. The combination device may be powered via a rechargeable battery or via a traditional wall outlet.

### CROSS-REFERENCE TO RELATED APPLICATION

The present application claims priority to and the benefit of U.S. Provisional Application No. 63/110,038 filed on Nov. 5, 2020, which is incorporated herein by reference in its entirety.

### FIELD OF THE INVENTION

The present invention relates generally to a new and improved scalp massaging device. More specifically, the invention relates to a wireless scalp massaging device that has a plurality of vibrating nubs that engage and massage the scalp of the user, wherein the vibration intensity, pressure and speed of the nubs are controllable and variable by the user through a controller. The scalp massaging device further comprises a plurality of apertures that allow air to exit the massage head of the device in a distributed manner to simultaneously dry the hair of the user while also massaging the user's scalp, and a wireless charging station that has a plurality of LED indicators that display the charging and power status of the device. Accordingly, the present specification makes specific reference thereto. However, it is to be appreciated that aspects of the present invention are also equally amenable to other like applications, devices, and methods of manufacture.

### BACKGROUND OF THE INVENTION

According to several studies, four to five-minute scalp massages may increase hair thickness by stretching the cells of hair follicles, which in turn stimulates the follicles to produce thicker hair. Further, scalp massages have shown that they may aid in the dilation of blood vessels under the scalp, which can also encourage hair growth. In addition, many users simply find scalp massages to be both relaxing and therapeutic.

A traditional scalp massage involves an individual utilizing their fingertips to apply pressure to their scalp, or the scalp of another, in a generally circular motion for approximately four to five minutes. Alternatively, a scalp massage may be performed in a more efficient and time-saving manner while an individual is concurrently washing or drying his or her hair. However, after a prolonged period of time, the individual's fingers may become fatigued, or the individual may experience pain and/or discomfort in the fingers, hands or wrist area as a result of performing prolonged or repetitive massages.

Alternatively, and in an effort to avoid the above referenced disadvantages associated with manual scalp massages, an individual may utilize a scalp massaging device. However, such devices suffer from a number of inherent limitations. For example, difficulty arises when an individual attempts to use a scalp massaging device in conjunction with the act of blow drying their hair. For many users, blow drying their hair serves as a natural time to also massage the scalp. Currently, this process typically involves using a scalp massaging device with one hand and a blow dryer with the other hand. However, this process is fundamentally problematic, as it does not allow the user to use any kind of hairbrush or comb while drying their hair as they have no free hand (e.g., one hand is occupied with the scalp massager and the other is occupied with the blow dryer). It is virtually impossible for a user to brush, comb or style their hair when both hands are already in use massaging and drying their hair.

Further, existing scalp massaging devices typically lack settings to control the speed and intensity of the massage. Stated differently, the user is unable to vary the speed and the strength of the massage device. Moreover, by virtue of the fact that an electrical outlet is needed, many individuals are constrained to using a hair dryer and/or a scalp massager forces only where there is a nearby electrical outlet. This is undesirable as it prevents individuals from massaging and/or drying their hair in various locations that do not contain nearby power outlets.

Therefore, there exists a long felt need in the art for an improved scalp massaging device the use of which does not cause undue pain or stiffness in the user's hands, fingers and wrist area. There is also a long felt need in the art for an improved scalp massaging device that allows a user to massage and blow dry their hair and scalp using only one handheld device, such that their other hand may be free to use a brush or comb or perform other tasks. Moreover, there is a long felt need in the art for a combination scalp massaging device and blow dryer that does not require an electrical connection to a traditional electrical wall outlet, thereby allowing a user to both massage his or her scalp and blow dry his or her hair virtually anywhere. Additionally, there is a long felt need in the art for a combination scalp massaging device and blow dryer that allows the user to easily control the speed and intensity of the scalp massage. Finally, there is a long felt need in the art for a combination scalp massaging and blow dryer device that is relatively inexpensive to manufacture and safe and easy to use.

The present invention, in one exemplary embodiment, discloses a personal grooming device. The grooming device comprises a cordless body and a massaging head that has a plurality of speed, pressure, and intensity-selectable scalp massaging nubs that vibrate, stimulate, and massage the scalp of the user. The massaging head also has a plurality of continuous apertures serviced by an internal baffle system that allows hot or cold air to exit the massage head to dry the hair of the user simultaneously while also massaging the scalp. The handle of the grooming device includes a temperature selection control to allow the user to change the temperature of the air exiting the device to suit user need and/or preference. The personal grooming device is preferably powered by a rechargeable integrated battery that may be charged via a wireless charging station. Alternatively, the personal grooming device may be powered by one of an alternating electrical current or a direct current. Finally, the personal grooming device may comprise a means to allow the user to change the pressure, speed, and intensity of the vibrating nubs for a customizable massage experience.

In this manner, the personal grooming device of the present invention accomplishes all of the forgoing objectives, and enables an individual to both massage and dry his or her hair with a single device that can be held with one hand while leaving the other hand free to, for example, brush or comb the hair. The personal grooming device also allows a user improved mobility due to its cordless nature, and provides a massage experience that can be customized to the user's preferences.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, is an improved personal grooming device comprised of a handle and massage head. The front surface of the massage head contacts the head and scalp surface of a user, and has a plurality of vibrating rubber nubs that massage the scalp of the user during use. The nubs are powered by an internal electric motor. In differing embodiments of the device, the nubs may be fixedly or removable attached to the massage head so as to allow different nub configurations to be inserted in the head by the user. The nubs may also be comprised of a plurality of different shapes, such as a triangular prism shape or cone shape, or other geometric configurations which may include a tip that is rounded, blunt, spherical, or some other shape to further customize the massage experience. A further embodiment of the personal grooming device may also include a kit having differing nub shapes, sizes, and constructions.

The front surface of the massage head of the personal grooming device further comprises a plurality of continuous apertures therein that allow warm or cold hair to exit the device to dry the hair of the user in concert with the scalp massaging action. The air is supplied by an internal fan through a series of passages disposed in the interior body of the device. The temperature of the expelled air may be controlled by the user via a temperature selection mechanism that may be located on the handle of the device. In differing embodiments of the personal grooming device, the temperature selection mechanism may be comprised of a button or other switch, a grooved channel and slider means, or an LCD touch screen. Further, the temperature selection mechanism may have a plurality of indicia that corresponds to varying power and temperature levels. Additionally, the personal grooming device may include a means to control the intensity, speed, and pressure of the vibration nubs that may be located on the handle or in another location along the device body for easy access by the user.

The personal grooming device further comprises a corresponding wireless charging station that has a plurality of red/green LED indicators that inform the user whether the device is fully charged or not. The wireless charging station is comprised of a recessed charging area that receives the handle of the personal grooming device, wherein the handle comprises a female charging member that matingly engages a male charging member in the recessed charging area of the charging station. Nonetheless, the charging station may be further comprised of an integrated power cord to allow the power station to be powered by a standard wall outlet when the same is available.

In one exemplary embodiment of the present invention, a kit for a personal care product is presented and includes a package for holding a personal care product and its accessories. The personal care product includes a handle attached to a shaped head, with the shaped head having a plurality of air flow apertures and a pattern of spaced apart protrusions on a face of the head. The pattern of air flow apertures and pattern of protrusions alternate with one another, and the pattern of protrusions is driven by a motor to vibrate the protrusions at a frequency of between 20 to 100 Hz per second. Further, the plurality of air flow apertures emit an air flow ranging from between 4 m/s to 7 m/s, and is distributed at a temperature preferably between about 100° F. to about 140° F. The above referenced frequency of vibration of the pattern of protrusion stimulates blood flow and promotes hair growth.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of one potential embodiment of the head portion of the personal grooming device of the present invention in accordance with the disclosed architecture, wherein air is being blown out of a plurality of apertures in the head portion;

FIG. 2 illustrates a close up perspective view of one potential embodiment of the massaging nubs present on the head portion of the personal grooming device of the present invention in accordance with the disclosed architecture;

FIG. 3 illustrates a close up perspective view of one potential embodiment of the handle portion of the personal grooming device of the present invention in accordance with the disclosed architecture;

FIG. 4 illustrates a perspective view of one potential embodiment of the personal grooming device of the present invention in accordance with the disclosed architecture, wherein the grooming device is being used by an individual to simultaneously massage her scalp and blow dry her hair;

FIG. 5 illustrates a perspective view of one potential embodiment of the charging station of the personal grooming device of the present invention in accordance with the disclosed architecture;

FIG. 6 illustrates a perspective view of one potential embodiment of a kit comprising the personal grooming device of the present invention in accordance with the disclosed architecture, wherein the kit further comprises the charging station and a plurality of different accessories for use with the personal grooming device; and

FIG. 7 illustrates a side elevational perspective view of one potential embodiment of the personal grooming device of the present invention in accordance with the disclosed architecture, wherein the air flow baffle and spray device are also illustrated.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

As noted above, there exists in the art a long felt need for a personal grooming device that enables the user to both massage and dry their hair and scalp using only one handheld device, such that their other hand may be free to use a brush or comb or perform other tasks, such as styling. There is also a long felt need in the art for a combined personal grooming device whose operation is not dependent on the close proximity of an electrical wall outlet. Moreover, there is a long felt need in the art for an scalp massaging device the use of which does not cause undue pain or stiffness in the user's hands, fingers and wrist area, and that allows the user to easily control the speed and intensity of the scalp massage.

The personal grooming device of the present invention is designed to allow a user to easily massage their scalp while simultaneously drying their hair. In addition, by applying the air directly to the roots of the hair (versus the ends of the hair), the user's hair will not dry out, avoids heat damage and remains easily manageable. As a result, the personal grooming device increases efficiency by allowing a user to complete two simultaneous tasks with a single hand, wherein two hands would normally be required. Therefore, a user has the opportunity to use their free hand to comb or brush their hair (a common practice) while drying and massaging their scalp or use the same to complete any other task. In addition, the personal grooming device provides improved mobility, and allows a user to utilize the device anywhere due to its cordless nature.

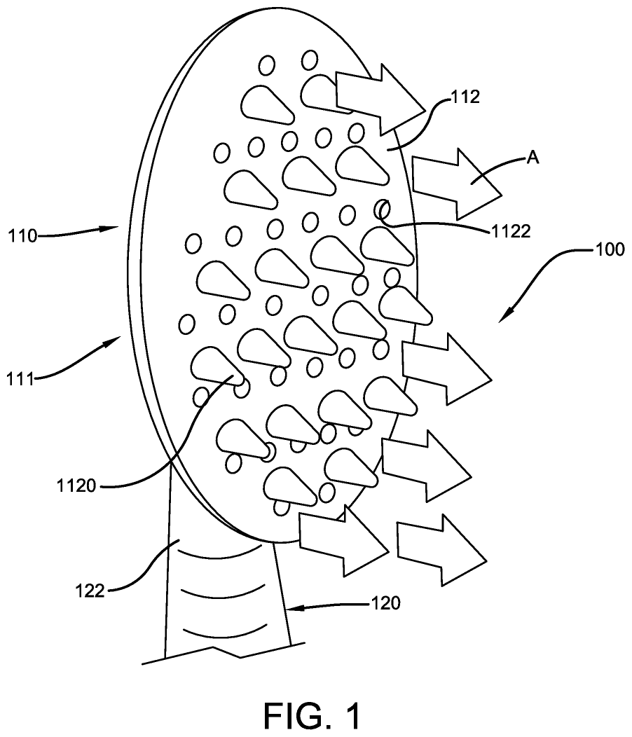

Referring initially to the drawings, FIG. 1 illustrates a perspective view of one potential embodiment of the head portion 111 of the personal grooming device 100 of the present invention in accordance with the disclosed architecture, wherein air (A) is being blown out of a plurality of continuous apertures 1122 in a face or front surface 112 of the head portion 111. More specifically, the personal grooming device 100 is comprised of a body portion 110 and a handle 120. The body portion 110 is further comprised of a massage head 111 having a front surface 112 with a plurality of spaced apart massaging nubs or protrusions 1120 and a plurality of spaced apart continuous openings or apertures 1122 thereon.

The handle portion 120 is generally cylindrical in shape and may, in differing embodiments, include a plurality of grooves 122 or finger contours to aid a user in gripping the handle 120. The handle 120 is further fixedly attached (e.g., molded in a one-piece construction) to the massage head 111, which may be generally oval or oblong in shape, but may also be generally square, triangular, circular, trapezoidal, etc. in differing embodiments of the personal grooming device 100. As stated above, the massage head 111 is comprised of a front surface 112 that contacts the head/scalp 12 of a user (which will be discussed more fully below) to massage the scalp and dry the user's hair. The body portion 110 is preferably comprised of a relatively lightweight and durable plastic, but may be manufactured from any other suitable materials, such as aluminum, stainless steel, etc.

As also noted above, the front surface 112 is comprised of a plurality of scalp massaging protrusions or nubs 1120. The nubs 1120 may have a plurality of different shapes or sizes and may be manufactured from the same material as the body portion 110, or another suitable material. For example, the nubs 1120 may be in the general shape of cones, triangular prisms, spheres, etc., and may be comprised of a relatively soft, flexible silicone or similar type of material. The nubs 1120 may also have a pointed (with a rounded edge) or blunted (e.g. flat) tip to engage the scalp of the user, without damaging the same, and may be of varying lengths when compared to one another.

In a preferred embodiment of the present invention, the personal grooming device 100 may further comprise a motor (not shown) that is positioned in the handle portion 120 or the body portion 110 and that is in mechanical communication with each of the plurality of nubs 1120. The motor allows the plurality of nubs 1120 to pulse or vibrate to stimulate the user's scalp. The frequency of the vibrations range from about 20 to 100 Hz per second, with about 20-60 Hz per second being preferred. The preferred range provides a level of vibration that both relaxes the muscles and stimulates blood flow, and may also expedite the healing of any wounds that may be present on the surface being massaged.

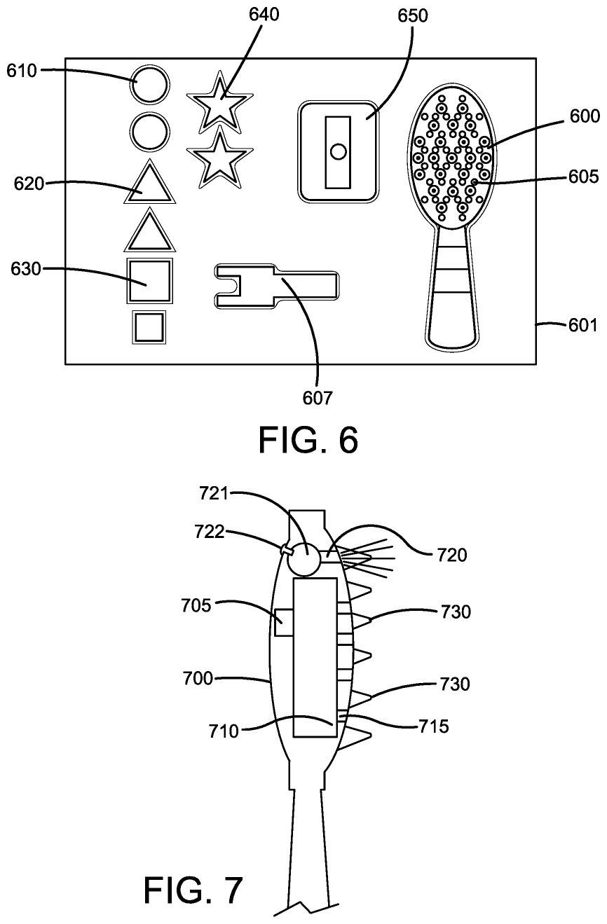

The personal grooming device 100 allows the user to control the frequency range of the vibrations in increments of 10 Hz. More specifically, the vibration means of the nubs 1120 may be variable and/or user-selected by a control that will be discussed more fully below when discussing the temperature selection mechanism 1202. The variability allows the user to control the vibration intensity, speed, and pressure of the nubs 1120 against the surface of a user's scalp. In an additional embodiment, the nubs 1120 may also undulate (while being powered by the electric motor) to further produce a differing massage experience for the user's scalp. Nonetheless, the nubs 1120 are not required to vibrate, and may simply be fixedly attached to the front surface 112 or removably attached to aid in cleaning. Also, as discussed more fully below in relation to FIG. 6, the personal grooming device 100 may be part of a kit that is further comprised of a plurality of differing nub 1120 shapes, sizes, and tip constructions to allow the user to interchange the nubs 1120 to suit user need and/or preference.

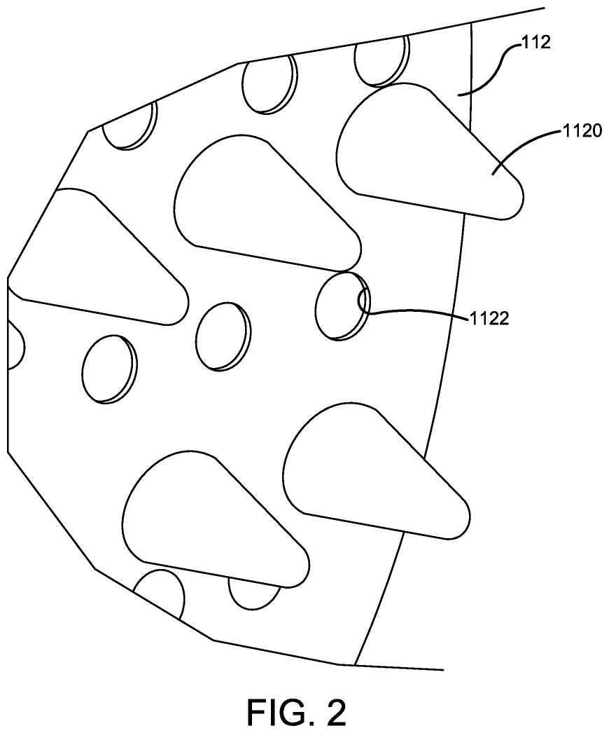

FIG. 2 illustrates a close up perspective view of one potential embodiment of the massaging nubs 1120 and apertures 1122 present on the head portion 111 of the personal grooming device 100 of the present invention in accordance with the disclosed architecture. More specifically, the personal grooming device 100 may further comprise a fan (not shown) and related heating element (also not shown) that is positioned within the body portion 110 or the handle portion 120 of the grooming device 100. The fan and accompanying heating element are in fluid communication with the plurality of continuous and spaced apart openings or apertures 1122 in the front surface 112 of the massage head 111 to allow hot or cold air (A) to exit the grooming device 100 to dry the hair/scalp of a user, while the same is being massaged.

The exit flow rate of the air at the aperture 1122 preferably ranges from about 4 m/s to 7 m/s depending on the speed selected by the user of the personal grooming device 100, and the temperature of the air preferably ranges from about 100° F. to about 140° F. The apertures 1122 are preferably arranged in a row and column-like fashion in between rows and columns of nubs 1120, which are also preferably arranged in a row and column-like fashion to form a pattern across substantially the entire front surface 112. In this manner, a maximum amount of surface area of the front surface 112 is utilized and is available for contact with the user's scalp and hair, thereby shortening the amount of time required to complete the massaging/drying and improving the overall efficiency of the device 100. Notwithstanding, in differing embodiments of the grooming device 100, the nubs 1120 and apertures 1122 may be arranged in a plurality of differing configurations or patterns such as, but not limited to, radially, spirally, or in a random configuration or any other pattern.

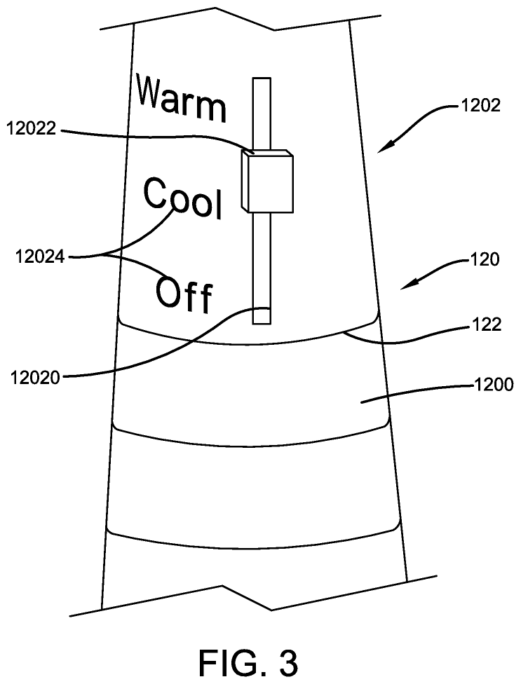

FIG. 3 illustrates a close up perspective view of one potential embodiment of the handle portion 120 of the personal grooming device 100 of the present invention in accordance with the disclosed architecture. More specifically, the handle 120 preferably comprises a plurality of grooves 122 that may run circumferentially around the handle 120 body to aid the user in securely gripping the handle 120. Notwithstanding, in differing embodiments of the grooming device 100, the surface of the handle 120 may have a plurality of differing textures such as, but not limited to, stippling, knurling, hatching, etc.

The handle 120 further comprises a temperature selection mechanism 1202 that allows a user to select the power setting and air temperature that the device 100 outputs via the massage head 111 apertures 1122. In a preferred embodiment of the grooming device 100, the temperature selection mechanism 1202 is a grooved channel 12020 that retains a slider 12022 which can be slid to the corresponding indica 12024 (e.g. “warm”, “cool”, “off”) to allow the air temperature or power setting of the device 100 to be controlled by the user. Notwithstanding, in another embodiment of the grooming device 100, the temperature mechanism 1202 may be in the form of a button, switch, or an LCD touch screen. In still another embodiment of the personal grooming device 100, the selection mechanism 1202 may also allow a user to vary the speed, pressure, and intensity of the vibrating nubs 1120. For example, the selection means may be a grooved channel, slider, and indicia similar to that which is described above, or may include a series of buttons or dials (not shown). Additional indicia 12024 may also be provided on the handle portion 120 that corresponds to specific settings or levels of speed, pressure, or intensity variability of the nubs 1120. It is also contemplated that the vibration nub selection mechanism may be used to control all of the nubs 1120, or only a select portion thereof. Importantly, the massaging and blow drying features of the personal grooming device 100 may be operated simultaneously, or independent of one another.

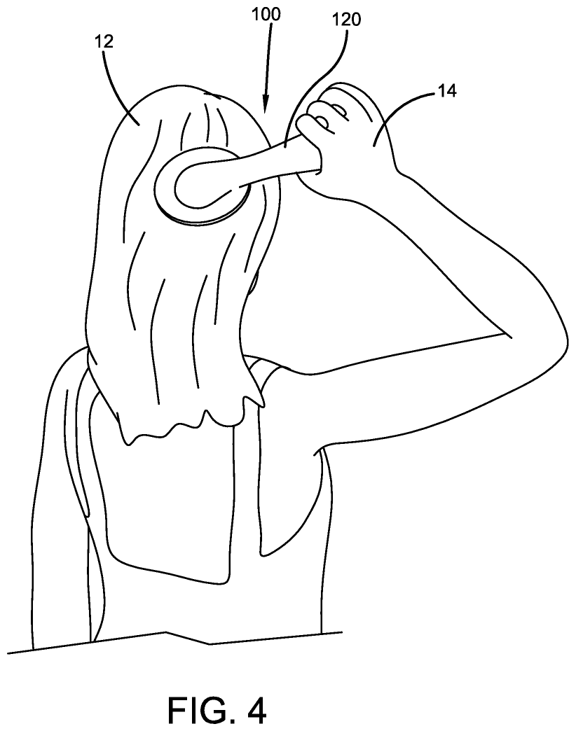

FIG. 4 illustrates a perspective view of one potential embodiment of the personal grooming device 100 of the present invention in accordance with the disclosed architecture, wherein the grooming device 100 is being used by an individual to simultaneously massage her scalp and blow dry her hair. More specifically, the personal grooming device 100 may be supported by a single hand 14 to allow the user to contact the head and scalp area 12 by grasping and articulating the handle portion 120. In this manner, the other hand of the user is free to perform other tasks, such as brushing or combing the hair, which ultimately provides a more convenient and efficient means of operation over the traditional practice of using one hand to use a massaging device and the other hand to use a blow-drying device.

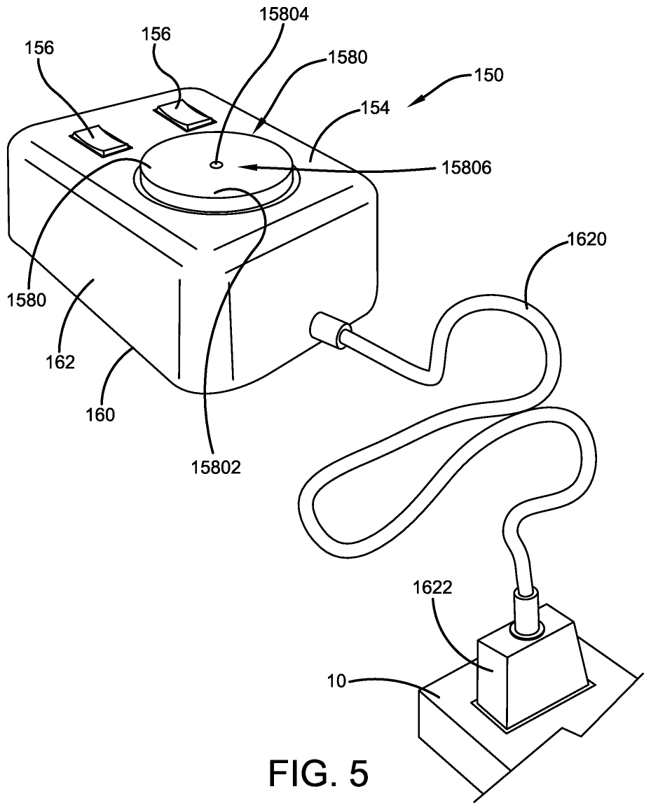

FIG. 5 illustrates a perspective view of one potential embodiment of the charging station 150 of the personal grooming device 100 of the present invention in accordance with the disclosed architecture. More specifically, the personal grooming device 100 is preferably powered by one or more single use or rechargeable batteries that may be charged via a wireless charging station 150. Alternatively, the personal grooming device 100 may be powered by one of an alternating electrical current or a direct current. If batteries are used as the power source, the batteries should be easily replaceable or removed if necessary. Suitable batteries include alkaline, nickel-cadmium, nickel-metal hydride, etc. Throughout this specification the terms “battery”, “battery pack”, and “batteries” may be used interchangeably to refer to one or more wet or dry cells or batteries of cells in which chemical energy is converted into electricity and used as a source of DC power. References to recharging or replacing batteries may refer to recharging or replacing individual cells, individual batteries of cells, or a package of multiple battery cells as is appropriate for any given battery technology that may be used.

The charging station 150 is comprised of a generally rectangular body 152 having a top surface 154 and rounded edges or corners, one or more LED indicators 156, a charging port 158, a bottom surface 160 and a plurality of sidewalls 162 extending between the bottom surface 160 and the top surface 154. Notwithstanding, the charging station 150 is not so limited, and may be comprised of other shapes and configurations as well. In the preferred embodiment 100, the LED indicators 156 are red and green indicators which serves to inform the user when the device 100 is fully charged (e.g., the green indicator is illuminated) or not fully charged (the red indicator is illuminated). However, in a differing embodiment, the charging station 150 may have an accompanying mobile application (not shown) that allows a user to view the charging status of their smartphone, as well as change the temperature setting and nub vibration speed, intensity, and pressure settings of the personal grooming device 100.

The charging port 158 is preferably cylindrical in shape and is comprised of a top surface 1580, a side surface 15802, a male charging member 15804 is positioned in, and extends outwardly from, the recessed area 15806 to engage a corresponding female charging member on the bottom of the handle 120 to allow the device to charge wirelessly by placing the handle 120 into the charging port 158. Nonetheless, in an alternative embodiment, the male charging member 15804 may be alternatively placed on the side surfaces 15802 of the charging port 158, or the charging port 158 may have a fixed male USB charging member such as USB-A, USB-C, USB-Micro, etc. and the handle 120 may have a corresponding female USB connection. Additionally, one sidewall 1582 of the charging station 150 may further include a fixedly or removably attached power cord 1620 that has a male outlet member 1622 which allows the power station to be powered by a traditional electrical wall outlet 10.

FIG. 6 illustrates a perspective view of one potential embodiment of a kit 601 comprising the personal grooming device 600 of the present invention in accordance with the disclosed architecture, wherein the kit 601 further comprises the charging station 650 and a plurality of different accessories for use with the personal grooming device. More specifically, the device 600 is shown with a plurality of apertures 605 and a tool 607 to allow the user to swap out the individual massaging units 610, 620, 630 and 640. The various massaging units 610, 620, 630 and 640 are shown with different geometric configurations including round, triangular, square, and star shaped, but it should be understood that any shape or configuration can be used. The kit 601 also includes a power charging unit 650, which can be used to charge the combination massaging and drying device 600.

FIG. 7 illustrates a side elevational perspective view of one potential embodiment of the personal grooming device 700 of the present invention in accordance with the disclosed architecture. More specifically, a fan 705 is used to provide heated or ambient air to the baffles 710 that feed each of apertures 715 to allow heated or cooled air to pass to the scalp and hair of the user. FIG. 7 also illustrates a spray 720, which may be used to add lift to the hair of the individual and provide conditioning or other hair care products to the head of the individual. More specifically, the spray 720 is emitted through a nozzle and can be controlled by a trigger. A reservoir 721 is provided for holding the spray until needed, which can be refilled through a cap 722. FIG. 7 also illustrates different sized and configurations of nubs 730 that may be used to provide vibrations to the scalp. The personal grooming device 100 may also be used with various massage styling gels to increase manageability and/or circulation. The device can also be used individually as a massager or a dryer or as a combination device, as the massager may be detached from the dryer.

Notwithstanding the forgoing, the personal grooming device 100 and its various components may be any suitable size, shape, and configuration as is known in the art without affecting the overall concept of the invention, provided that the same accomplishes the above stated objectives. One of ordinary skill in the art will appreciate that the shape and size of the personal grooming device 100 and its various components, as shown in the FIGS. are for illustrative purposes only, and that many other shapes and sizes of the personal grooming device 100 are well within the scope of the present disclosure. Although dimensions of the personal grooming device 100 and its components (i.e., length, width, and height) are important design parameters for good performance, the personal grooming device 100 and its various components may be any shape or size that ensures optimal performance during use and/or that suits user need and/or preference.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A personal grooming device comprising:
a handle;
a head portion connected to the handle, wherein the head portion is comprised of a face portion having a plurality of protrusions and a plurality of continuous apertures extending through said face portion;
a fan for producing a flow of air through each of the plurality of continuous apertures; and
a motor for causing the plurality of protrusions to vibrate.

2. The personal grooming device as recited in claim 1 further comprising a heating element for heating the flow of air.

3. The personal grooming device as recited in claim 1, wherein the vibrations are within a frequency of between 20 and 100 Hz per second.

4. The personal grooming device as recited in claim 1, wherein the vibrations are within a frequency of between 20 and 60 Hz per second.

5. The personal grooming device as recited in claim 1, wherein the flow of air ranges from between 4 m/s to 7 m/s.

6. The personal grooming device as recited in claim 1, wherein the flow of air has a temperature of between 100° F. to about 140° F.

7. The personal grooming device as recited in claim 1, wherein the plurality of protrusions are comprised of at least two different geometric configurations.

8. The personal grooming device as recited in claim 1, wherein the plurality of protrusions are removable and interchangeable.

9. The personal grooming device as recited in claim 1, wherein the plurality of protrusions are arranged in a first pattern and the plurality of continuous apertures are arranged in a second pattern.

10. The personal grooming device as recited in claim 1 further comprising a sprayer and a nozzle.

11. A combination scalp massager and hair drying device comprising:
a handle comprising a grip surface;
a head connected to the handle, wherein the head is comprised of a first pattern of air flow apertures and a second pattern of protrusions;
a controller for changing a temperature of an air flow passing through the first pattern of air flow apertures, wherein the controller also causes the second pattern of protrusions to vibrate; and
a power source for supplying power to the combination scalp massager and hair drying device, wherein the power source is one of a rechargeable battery, an alternating current or a direct current.

12. The combination scalp massager and hair drying device as recited in claim 11, wherein a frequency of the vibrations ranges from about 20 to 100 Hz.

13. The combination scalp massager and hair drying device as recited in claim 11, wherein a frequency of the vibrations ranges from about 20 to 60 Hz.

14. The combination scalp massager and hair drying device as recited in claim 11, wherein a flow rate of the air flow as it passes through the first pattern of air flow apertures is in a range of 4 m/s to 7 m/s and an air flow temperature range of about 100° F. to about 140° F.

15. The combination scalp massager and hair drying device as recited in claim 11, wherein the first pattern of air flow apertures alternates with the second pattern of protrusions.

16. The combination scalp massager and hair drying device as recited in claim 11, wherein the second pattern of protrusions includes a number of individual protrusions that are removable from the head and interchangeable.

17. The combination scalp massager and hair drying device as recited in claim 16, wherein the number of individual protrusions may include different geometries.

18. A kit for massaging and blow drying an individual's head comprising:
a personal care product comprising a handle attached to a shaped head, wherein the shaped head is comprised of a plurality of air flow apertures and a plurality of protrusions, and further wherein the plurality of air flow apertures and the plurality of protrusions alternate with one another;
a motor for causing the plurality of protrusions to vibrate at a frequency of between 20 to 100 Hz per second;
a fan for creating an air flow that passes through the plurality of air flow apertures at a velocity ranging from between 4 m/s and 7 m/s and at a temperature ranging from between 100° F. and 140° F.;
a battery for powering the motor and the fan; and
a controller for controlling the motor and the fan.

19. The kit for massaging and blow drying an individual's head as recited in claim 18 further comprising a plurality of removable and interchangeable protrusions having different shapes and configurations.

20. The kit for massaging and blow drying an individual's head as recited in claim 18, further comprising a charging station.
